(19) United States
(12) Patent Application Publication
(10) Pub. No.: US 2025/0042801 A1
(43) Pub. Date: Feb. 6, 2025

(54) LIGHT DIFFUSING GLASS CERAMICS

(71) Applicant: CORNING INCORPORATED, CORNING, NY (US)

(72) Inventors: Jesse Kohl, Horseheads, NY (US); Mark Owen Weller, Painted Post, NY (US)

(21) Appl. No.: 18/713,958

(22) PCT Filed: Nov. 22, 2022
(86) PCT No.: PCT/US2022/050690

§ 371 Date: May 28, 2024

Related U.S. Application Data
(60) Provisional application No. 63/284,179, filed on Nov. 30, 2021.

(51) Int. Cl. C03C 4/00; C03C 10/00; G02B 5/02

(52) U.S. Cl. CPC C03C 4/005; C03C 10/0027; G02B 5/0268; G02B 5/0278

(57) ABSTRACT

A glass composition is provided wherein the composition exhibits wavelength independent scattering of visible light. The glass composition may comprise a spontaneously opalizing glass composition. The glass composition may comprise a fusion formable ceramic glass composition. The glass composition comprises crystals having a size greater than or equal to 1 μm. A targeted total transmittance value of the glass composition is 50% to 80%. The glass composition is configured for use as a light diffuser for a backlit display panel. The glass composition is configured such that the light diffuser appears white in transmission. A light diffuser for a backlit display panel is provided. The light diffuser may comprise a laminate comprising a core layer comprising a clear glass, and a clad layer comprising a fusion formable ceramic glass composition. The laminate may comprise a double fusion laminate.

This application claims the benefit of priority of U.S. Provisional Application Ser. No. 63/284,179 filed on Nov. 30, 2021, the content of which is relied upon and incorporated herein by reference in its entirety.

### FIELD

This disclosure generally relates to glass ceramics, and particularly relates to light diffusing glass ceramics.

### BACKGROUND

Backlit liquid crystal displays (LCDs) employ a light diffusing layer to uniformly spread the emission of light emitting diodes (LEDs) across the panel. The diffuser layers are typically 2-3 mm in thickness and made of a polymer (such as polymethylmethacrylate (PMMA) or polycarbonate) doped with silica particles. Silica is used because it has nearly no absorbance of visible wavelengths and has a higher refractive index than the polymer, resulting in light scattering.

To increase brightness and improve local dimming, panel makers are increasing the power and total number of LEDs in backlit panels. However, the increased power and number of LEDs results in an increased operating temperature, causing the polymers in the panel to expand and deform. Thick bezels are required around the display panel edges to hide the large expansion of the diffuser panel. Accordingly, an alternative light diffuser solution is required that allows for manufacture of high brightness, thin bezel displays.

### SUMMARY

An aspect of the present disclosure is directed to a glass composition. The glass composition comprises from about 60 mol % to about 82 mol % SiO₂, from about 2.1 mol % to about 12 mol % Al₂O₃, from about 0 mol % to about 15 mol % B₂O₃, from about 5 mol % to about 18 mol % Na₂O, from about 0 mol % to about 3 mol % MgO, from about 2.5 mol % to about 12 mol % CaO, and from about 0.15 mol % to about 7 mol % P₂O₅.

In an embodiment, the composition comprises from about 63 mol % to about 80 mol % SiO₂, from about 2.5 mol % to about 8 mol % Al₂O₃, from about 0 mol % to about 10 mol % B₂O₃, from about 7 mol % to about 15 mol % Na₂O, from about 0 mol % to about 2.5 mol % MgO, from about 3 mol % to about 10 mol % CaO, and from about 0.5 mol % to about 5.5 mol % P₂O₅.

In an embodiment, the composition comprises from about 65 mol % to about 77 mol % SiO₂, from about 3 mol % to about 6 mol % Al₂O₃, from about 0 mol % to about 7.5 mol % B₂O₃, from about 10 mol % to about 12 mol % Na₂O, from about 0 mol % to about 1 mol % MgO, from about 4 mol % to about 8.5 mol % CaO, and from about 1 mol % to about 4 mol % P₂O₅.

In an embodiment, the glass composition comprises a spontaneously opalizing glass composition. In an embodiment, the glass composition opalizes without requiring heat treatment.

In an embodiment, the composition exhibits wavelength independent scattering of visible light. In an embodiment, the composition produces crystals having a size greater than or equal to 1 μm. In an embodiment, a targeted total transmittance value of the glass composition comprises a transmittance of 50% to 80%.

In an embodiment, the glass composition is configured for use as a light diffuser for a backlit display panel. In an embodiment, the composition is configured such that the light diffuser appears white in transmission. In an embodiment, the light diffuser has a thickness from 0.5 mm to 1.5 mm.

In an embodiment, the glass composition may be formed by rolling forming methods. In an embodiment, the glass composition comprises a textured surface.

In an embodiment, the glass composition does not contain fluorine (F), barium (Ba), lead (Pb), or a combination thereof. In an embodiment, the glass composition does not contain lithium (Li), zinc (Zn), tungsten (W), molybdenum (Mo), or a combination thereof.

An aspect of the present disclosure is directed to a glass composition. The glass composition comprises from about 79.75 mol % to about 80.09 mol % SiO₂, from about 5.40 mol % to about 5.44 mol % Al₂O₃, from about 10.59 mol % to about 10.69 mol % Li₂O, from about 0 mol % to about 0.11 mol % Na₂O, from about 3.80 mol % to about 3.84 mol % K₂O, from about 0.1110 mol % to about 0.1486 mol % P₂O₅, and from about 0 to about 0.01 mol % TiO₂.

In an embodiment, the glass composition is a ceramic glass composition. In an embodiment, the glass composition is configured for fusion forming. In an embodiment, the glass composition is configured for single fusion forming or double fusion forming.

In an embodiment, the glass composition comprises a ceraming step during forming.

In an embodiment, the ceraming step comprises a single stage heat treatment at a temperature from 700° C. to 850° C. In an embodiment, the single stage heat treatment occurs for a time period from 15 minutes to 4 hours.

In an embodiment, the ceraming step comprises a two-step heat treatment comprising a nucleation step followed by a growth step. In an embodiment, the nucleation step is carried out at temperatures in a range from 600° C. to 650° C. from about 15 minutes to about 90 minutes. In an embodiment, the growth step is carried out at temperatures in a range from 750° C. to 850° C. from about 1.5 hours to about 4 hours.

In an embodiment, the glass composition comprises a smooth surface from fusion forming. In an embodiment, the smooth surface is configured for film deposition.

In an embodiment, the glass composition does not contain fluorine (F), barium (Ba), lead (Pb), or a combination thereof.

In an embodiment, the composition exhibits wavelength independent scattering of visible light. In an embodiment, the composition produces crystals having a size greater than or equal to 1 μm. In an embodiment, a targeted total transmittance value of the glass composition comprises a transmittance of 50% to 80%.

In an embodiment, the glass composition is configured for use as a light diffuser for a backlit display panel. In an embodiment, the composition is configured such that the light diffuser appears white in transmission. In an embodiment, the light diffuser has a thickness from 0.5 mm to 1.5 mm.

An aspect of the present disclosure is directed to a light diffuser for a backlit display panel. The light diffuser comprises a laminate comprising: a core layer comprising a clear glass, and a clad layer comprising a ceramic glass composition.

In an embodiment, the ceramic glass composition is a glass composition according to the present disclosure. In an embodiment, the composition is configured such that the light diffuser appears white in transmission. In an embodiment, the light diffuser has a thickness from 0.5 mm to 1.5 mm. In an embodiment, the laminate is a double fusion laminate. In an embodiment, the clad layer comprises two layers disposed on opposite surfaces of the core layer.

In an embodiment, the core layer glass and the clad layer glass are selected to tune optical properties. In an embodiment, a ceram schedule during forming of the laminate is tunable. In an embodiment, a ratio of core thickness to clad thickness is tunable. In an embodiment, a delta coefficient of thermal expansion (CTE) between the core layer glass and the clad layer glass is tunable.

Additional aspects of the present disclosure will be set forth, in part, in the detailed description, figures and any claims which follow, and in part will be derived from the detailed description, or can be learned by practice of the disclosure. It is to be understood that both the foregoing general description and the following detailed description are exemplary and explanatory only and are not restrictive of the disclosure as disclosed.

### BRIEF DESCRIPTION OF THE DRAWINGS

FIG. 1 shows an image of a spontaneous opal glass ceramic 932NN according to an embodiment of the present disclosure.

FIG. 2 shows total transmittance of an incumbent polymer diffuser compared to thicknesses of spontaneous opal glass sample 932NN according to an embodiment of the present disclosure.

FIG. 3 shows a powder XRD of spontaneous opal glass sample 932NN according to an embodiment of the present disclosure.

FIG. 4 shows transmission spectra of an incumbent polymer diffuser and modified fusion formable glass ceramic 924EA according to an embodiment of the present disclosure.

FIG. 5 shows an image of fusion formable glass ceramic sample 924EZ according to an embodiment of the present disclosure.

FIG. 6 shows transmission spectra of an incumbent polymer diffuser compared to fusion formable glass ceramic 924EZ according to an embodiment of the present disclosure.

FIG. 7 shows a powder XRD profile of sample 924ENP according to an embodiment of the present disclosure.

FIG. 8 shows images in reflection and transmission of samples 924ELF, 924ENP, 924ENQ, 924ENR, 924ENS, 924ENT, and 924ENU according to embodiments of the present disclosure.

FIG. 9 shows images of sample 924ELF heat treated for varying heat treatment times and temperatures according to embodiments of the present disclosure.

FIG. 10 shows powder XRD of samples 924ELD-F and 924ENP-U according to embodiments of the present disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

Glass ceramic opals provide a technical alternative to polymer diffuser panels because the thermal expansion of glass and glass ceramic opals can be engineered to be less than half that of PMMA. Further, the glass ceramic opals may remain rigid, even at elevated operating temperatures, allowing for increased dimensional stability of the display while in operation. However, conventional light diffusing opal glasses, such as those used as shades for oil and gas lamps, are produced with non-environmentally friendly species, such as fluorine, barium, and lead. Moreover, due to their instability, the existing light diffusing opal glasses could not be formed by fusion methods or float methods.

In an aspect of the present disclosure, opal glass compositions or ceramic glass compositions are provided that use environmentally sustainable batch constituents. In an embodiment, an opal glass or ceramic glass comprises a composition that is environmentally sustainable or that does not comprise non-environmentally sustainable constituents. In an embodiment, a glass composition as described herein does not contain fluorine (F) or is fluorine-free. In an embodiment, a glass composition as described herein does not contain barium (Ba) or is barium-free. In an embodiment, a glass composition as described herein does not contain lead (Pb) or is lead-free. In an embodiment, a glass composition according to the present disclosure are free of tungsten (W) and molybdenum (Mo), which are expensive raw materials. In an embodiment of the present disclosure, a glass composition is substantially free of titanium dioxide (TiO₂). In an embodiment, a glass composition as described herein does not contain Zinc (Zn) or is zinc-free.

In an embodiment, opal glass or ceramic glass compositions described herein may be used as light diffusers. For instance, opal glass or ceramic glass compositions described herein may provide solutions to replace polymers in LCD panel display diffusers. Opal glass and ceramic glass articles as described herein offer different levels of performance and cost, which are important aspects when considering alternatives to polymer diffusers for display applications, as the polymer diffusers, while limited in performance, are typically low cost.

To be used as a light diffuser for backlit display panels, such a light diffuser must have minimal absorbance of visible wavelengths and provide uniform wavelength independent scattering of visible light. Conventional polymer diffuser panels have about 60% total transmittance at thicknesses of about 2 mm. Glass and glass ceramics can be engineered to have a much lower CTE than polymers, can provide greater dimensional stability at elevated temperatures, and can take the thermal load from the bright LEDs without warping. In an embodiment, a glass or glass ceramic composition is provided that achieves a total transmittance value in a range from 50% to 80% when the glass or glass ceramic article comprises a thickness from 0.5 mm to 1.5 mm.

Conventional or previously manufactured opal glass and glass ceramics were designed specifically to be dense and to appear white in reflected light. Research conducted on opal glass throughout the late nineteenth and twentieth centuries centered on developing compositions that were white in reflection and strongly scattering such that very little light transmitted through and such that the opal glasses simulated the appearance of porcelain. Such strongly scattering white glasses are also referred to as “dense opals”. Color in transmitted light was not a key consideration of conventional opal glass or ceramic glass. Most conventional opal glasses have a color when viewed in transmission which is due wavelength dependent scattering and which results in a yellow, amber, or reddish appearance, depending on the particle size distribution or length scale of phase separation present (in the case of non-crystalline phase separated opals). In contrast, an opal glass or ceramic glass to be used for light diffuser applications such as described in the present disclosure requires high transmittance (50-70%) and wavelength independent scattering of visible light.

In an embodiment, the opal glass or glass ceramic compositions described herein provide wavelength independent scattering. Glass ceramic articles according to the present disclosure do not exhibit an optical effect such as a “mother-of-pearl” or iridescent surface resulting from light refraction from elongated crystals on or near the glass surface-such an optical effect would not be suitable for a light diffuser, where wavelength independent scattering is needed. In an embodiment, the opal glass or glass ceramic composition has a white or translucent appearance. In an embodiment, opal glasses or ceramic glasses according to the present disclosure are not dense.

Further, many conventional opal glasses and glass ceramic compositions produce too many crystals or crystals that are too small, resulting in opals that are too opaque, produce wavelength dependent scattering, or both. In examples of opal glasses that have high transmittance but exhibit strong wavelength dependent scattering, the color shift and its magnitude are directly related to the particle size, shape, and the refractive index delta in between the particle and the host matrix. In embodiments of the present disclosure, glass compositions comprise light scattering which manifests from formation of crystals. To achieve wavelength independent scattering such that the diffuser appears white in transmission, sufficiently large crystals are required, such as greater than or equal to 1 μm.

Heat treatment was also a challenge in developing the desired optical properties for a light diffuser opal glass. If the heat treatment times were kept short, some opal glasses (and glass ceramics) could achieve the target transmittance within the desired thickness range, but failed to produce coarse enough crystals to produce to uniformly scatter all visible wavelengths and thus were yellow or red in transmission. If heat treatment times were increased, some opal glasses produced sufficiently coarse crystals that uniformly scattered all visible wavelengths, but because of the overabundance of crystals, the opal glasses were too opaque. Thus, a challenge to developing an opal glass or ceramic glass for use as a light diffuser was the growth of sufficiently large crystals (such as greater than or equal to 1 μm) to scatter all visible wavelengths uniformly and grow sufficiently few of the crystals to meet the targeted transmittance.

In concept, a technical solution to such a problem is to reduce the thickness of the opal glass, or to reduce its path length. However, a problem exists with such a concept due to handling difficulties. For example, difficulties exist when handling large panels of thin material, such as having a thickness of about 0.1 to 0.3 mm. Because of the risk of breakage during assembly, mass producing large display panels with a thin, brittle, glass ceramic diffuser layer would be impractical.

In an aspect of the present disclosure, opal glass and ceramic glass compositions are provided. The compositions described herein may be formed by different processes. In an embodiment, the compositions may be configured for use in creating thin light diffuser panels for backlit displays. In an embodiment, a thickness of a light diffuser panel may be from about 0.5 mm to about 1.5 mm. In an embodiment, a light diffuser panel may have a thickness of up to about 1.5 mm.

Opal glass and ceramic glass diffusers as described in embodiments herein may exhibit a lower coefficient of thermal expansion (CTE) and superior thermal stability compared to polymer diffusers. Glass ceramics provide higher stiffness at elevated temperatures and reduced thicknesses, thereby allowing for thinner display panels. In addition, glass surfaces are more amenable to film deposition than polymers or rolled glasses because glass surfaces may be exposed to higher temperatures.

Unlike most opal glasses and glass ceramics, compositions described in embodiments herein are free of environmentally unfriendly batch constituents. In some embodiments, compositions described herein are substantially free of environmentally unfriendly batch constituents. Moreover, opal glasses and glass ceramics as described herein may be cost advantaged, as the compositions comprise no lithium or comprise half the lithium typically contained in conventional opal glass or glass ceramic compositions.

Glass compositions described in embodiments herein allow for a range of forming techniques, including fusion or single fusion forming, double fusion forming, and rolling forming. In an embodiment, a glass composition described herein may be float compatible.

Fusion and float formable compositions allow for light diffusers with smooth surfaces to be produced, unlike rolled glasses, which may have a texture. Such flat surfaces allow for facile film deposition. If no film deposition is required, rolling may allow for texturing of the surface or surfaces, which will promote light scattering.

### Spontaneously Opalizing Glass

In an aspect, glass compositions are provided wherein the compositions opalize spontaneously upon cooling to develop light scattering properties. The compositions may be low in cost due to containing no lithium. However, due to being unstable, such glass ceramics typically cannot be fusion formed, drawn by slot, or floated. Therefore, sheets may be formed by the rolling method, which may be limited by the sheet size. However, rolling may allow for texture on the sheet surfaces, which may be used to scatter light. A challenge when scaling the method of rolling is cooling, which impacts how the glass cerams, and thus, the composition and process affect the resultant light diffusing properties of the formed glass.

In an aspect of the present disclosure, a glass composition is provided wherein the glass composition spontaneously opalizes upon cooling. Glass compositions which spontaneously opalize upon cooling do not require a heat treatment or ceram step. The glass composition may comprise optical properties configured for use as a light diffuser.

Opal glass compositions according to the present disclosure allow for low cost forming, such as by a rolling forming method. During the rolling forming method, texture may be added to the glass surfaces to enhance scattering of light. In an embodiment, the glass composition may be formed by a rolling forming method. In an embodiment, the glass composition may be formed by a float forming method. Such rolling or float forming methods may be less expensive than fusion forming methods.

The composition of the glass may provide a low temperature spontaneous opal. Such a spontaneous opal glass allows for low cost melting because there is no need for a Pt tank, allows for low cost forming using the rolling method, and allows for surface texture at no extra costs due to rolling. In addition, such a glass is low cost because it does not contain lithium (Li) and does not require a ceram step. Such an opal glass may comprise a light anneal step, but does not require a ceraming step. However, rolling may be limited by size (for example, if a sufficiently large size sheet of glass is required to be rolled) or difficulty in control of optical properties, such as due to the combination of the process of forming and the composition.

Sample opal glass compositions which spontaneously opalize according to embodiments of the present disclosure are provided in Table 1.

TABLE 1
Compositions of opal glass samples which spontaneously opalize

| As-Batched | Sample | | | | | |
|---|---|---|---|---|---|---|
| mole % | 932NM | 932NN | 932NY | 932NZ | 932OC | 932OD |
| SiO₂ | 77.154 | 67.339 | 66.249 | 65.241 | 66.748 | 65.750 |
| Al₂O₃ | 3.392 | 5.568 | 5.561 | 5.560 | 5.561 | 5.561 |
| B₂O₃ | 0.000 | 7.137 | 7.127 | 7.126 | 7.127 | 7.127 |
| Na₂O | 11.129 | 11.418 | 11.402 | 11.400 | 11.402 | 11.402 |
| K₂O | 0.000 | 0.000 | 0.000 | 0.000 | 0.000 | 0.000 |
| MgO | 0.000 | 0.000 | 0.135 | 0.149 | 0.135 | 0.134 |
| CaO | 5.866 | 6.018 | 7.008 | 8.006 | 7.008 | 7.008 |
| SrO | 0.002 | 0.002 | 0.002 | 0.002 | 0.002 | 0.002 |
| BaO | 0.000 | 0.000 | 0.001 | 0.001 | 0.001 | 0.001 |
| P₂O₅ | 2.437 | 2.500 | 2.497 | 2.496 | 1.997 | 2.996 |
| Fe₂O₃ | 0.008 | 0.007 | 0.007 | 0.007 | 0.007 | 0.007 |
| Cl— | 0.001 | 0.001 | 0.001 | 0.001 | 0.001 | 0.001 |
| TiO₂ | 0.012 | 0.010 | 0.010 | 0.010 | 0.010 | 0.010 |
| Total | 100 | 100 | 100 | 100 | 100 | 100 |

Due to having low liquidus viscosities, the sample compositions in Table 1 are not suitable for fusion forming. However, sample compositions listed in Table 1 may be rolled into sheets. Rolling allows the surfaces to be embossed with a texture to further enhance the light scattering.

In an embodiment, a glass ceramic article comprises a spontaneously opalizing glass ceramic article. In an embodiment, the glass ceramic article opalizes without requiring heat treatment. In an embodiment, the spontaneously opalizing glass ceramic article is a light diffuser. In an embodiment, the spontaneously opalizing glass ceramic article may be formed by rolling forming methods.

Table 2 lists composition ranges for a spontaneously opalizing glass ceramic article according to an embodiment of the present disclosure.

TABLE 2
Composition ranges for glasses that spontaneously opalize

| | Range A | | Range B | | Range C | |
|---|---|---|---|---|---|---|
| | min | max | min | max | min | max |
| Components | (mol %) | (mol %) | (mol %) | (mol %) | (mol %) | (mol %) |
| SiO₂ | 60 | 82 | 63 | 80 | 65 | 77 |
| Al₂O₃ | 2.1 | 12 | 2.5 | 8 | 3 | 6 |
| B₂O₃ | 0 | 15 | 0 | 10 | 0 | 7.5 |
| Na₂O | 5 | 18 | 7 | 15 | 10 | 12 |
| MgO | 0 | 3 | 0 | 2.5 | 0 | 1 |
| CaO | 2.5 | 12 | 3 | 10 | 4 | 8.5 |
| P₂O₅ | 0.15 | 7 | 0.5 | 5.5 | 1 | 4 |

In an embodiment, a spontaneously opalizing glass ceramic article has a composition comprising about 60-82 mol % SiO₂, about 2.1-12 mol % Al₂O₃, about 0-15 mol % B₂O₃, about 5-18 mol % Na₂O, about 0-3 mol % MgO, about 2.5-12 mol % CaO, and about 0.15-7 mol % P₂O₅. In an embodiment, a spontaneously opalizing glass ceramic article has a composition comprising about 63-80 mol % SiO₂, about 2.5-8 mol % Al₂O₃, about 0-10 mol % B₂O₃, about 7-15 mol % Na₂O, about 0-2.5 mol % MgO, about 3-10 mol % CaO, and about 0.5-5.5 mol % P₂O₅. In an embodiment, a spontaneously opalizing glass ceramic article has a composition comprising about 65-77 mol % SiO₂, about 3-6 mol % Al₂O₃, about 0-7.5 mol % B₂O₃, about 10-12 mol % Na₂O, about 0-1 mol % MgO, about 4-8.5 mol % CaO, and about 1-4 mol % P₂O₅.

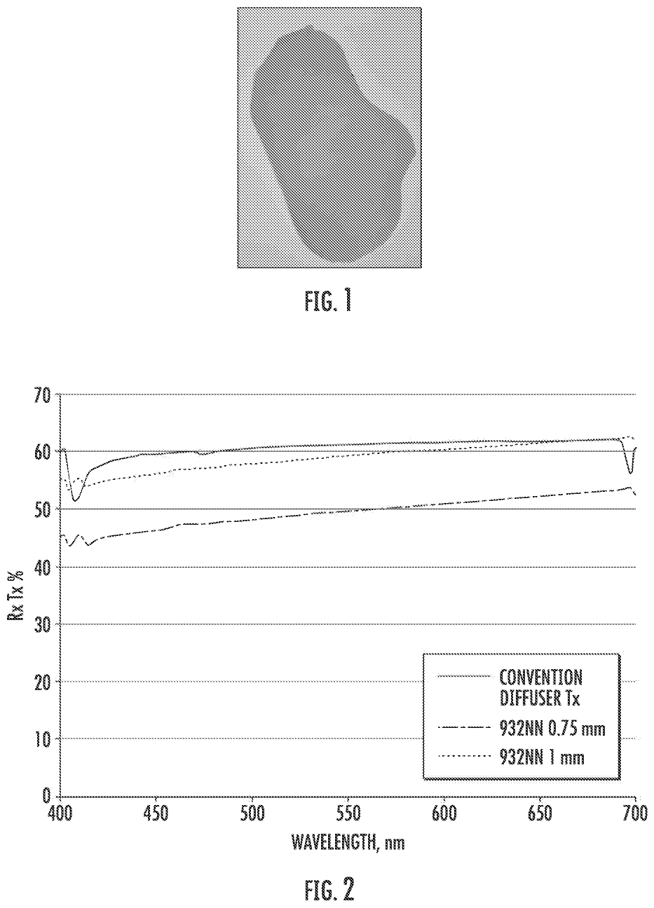

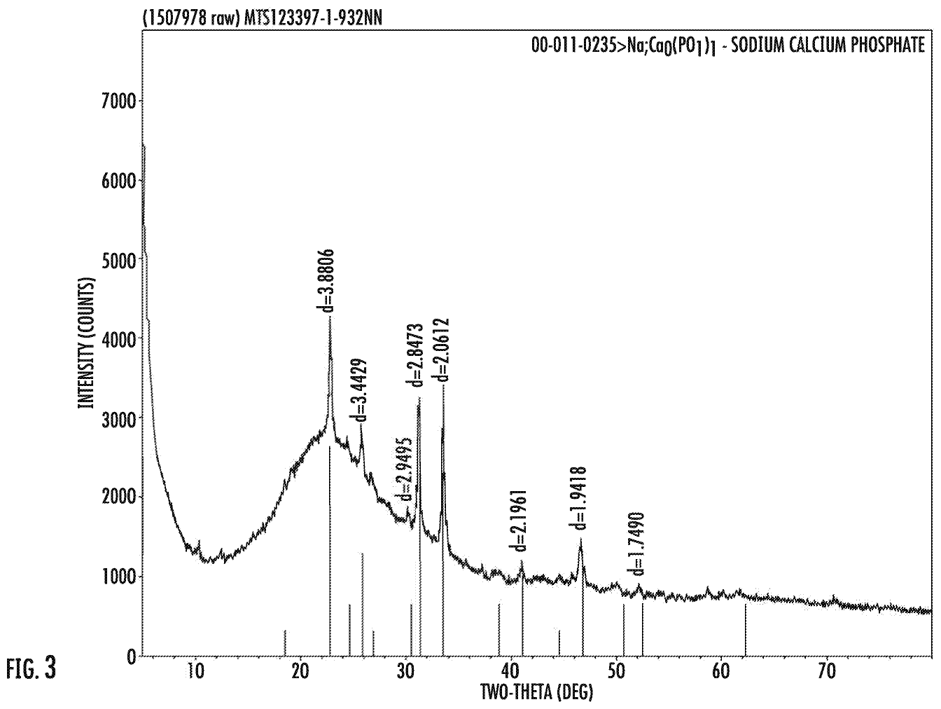

FIG. 1 shows an image of backlit sodium calcium phosphate (Na₃Ca₆(PO₄)₅ spontaneous opal glass ceramic 932NN at 1 mm thickness. FIG. 2 shows total transmittance of an incumbent polymer diffuser (referred to as Conventional Diffuser) versus 932NN at 0.5 mm thickness and 1.0 mm thickness.

FIG. 3 shows powder XRD of sodium calcium phosphate (Na₃Ca₆(PO₄)₅ spontaneous opal glass ceramic 932NN.

### Single Fusion Ceramic Glass

An aspect of the present disclosure is directed to a glass composition that is fusion formable. The glass composition may be ceramable or a ceramic glass. The fusion formable glass composition may be configured for single fusion. In an embodiment, the glass composition may be configured for use as a light diffusing ceramic glass.

Such a ceramic glass allows for formation of smooth surfaces, thereby allowing for film deposition. Uniform optical properties may be obtained, due to symmetrical cooling across the sheet.

In an embodiment, the ceramic glass may be formed by a single fusion method. The composition of the ceramic glass may provide a moderate to high temperature ceramable opal. Such a ceramic glass may provide smooth surfaces which allow film deposition, and such a ceramic glass may also provide for reproducible optical properties through a ceraming step. Because such a glass requires a ceraming step, costs of fusion may be more expensive than forming by rolling, and a smooth surface may not scatter effectively as a textured surface. However, typically custom equipment or forming assets would not be required, as existing single fusion forming assets may be used for such forming.

In an embodiment, fusion formable glass ceramics are provided that develop optical properties when heat treated or ceramed. By modifying the glass composition and tailoring the ceram schedule, suitably high transmittance and wavelength independent scattering may be achieved at the target thickness range of about 0.6 mm to about 1.5 mm. Such fusion formable glass compositions allow for the manufacture of large sheet sizes with smooth surfaces for film deposition, but typically result in a higher expense or cost than rolling forming methods. Additionally, because such fusion formable glass ceramic compositions contain Li and require a heat treatment to develop optical properties, such fusion formable glass ceramics are more expensive than spontaneously opalizing glass ceramics described in embodiments herein.

Reference example or conventional fusion formable glass ceramic 924EA was investigated. Reference 924EA can produce wavelength independent scattering, but can only produce the target 60% total transmittance at thicknesses less than 0.4 mm. While such a composition may be suitable to be used as a thin clad layer (such as less than 0.4 mm) in a double fusion laminate, such a composition in a single-ply or single layer would not be suitable and would not achieve the desired optical properties for a 0.5 mm to 1.5 mm thick diffuser panel.

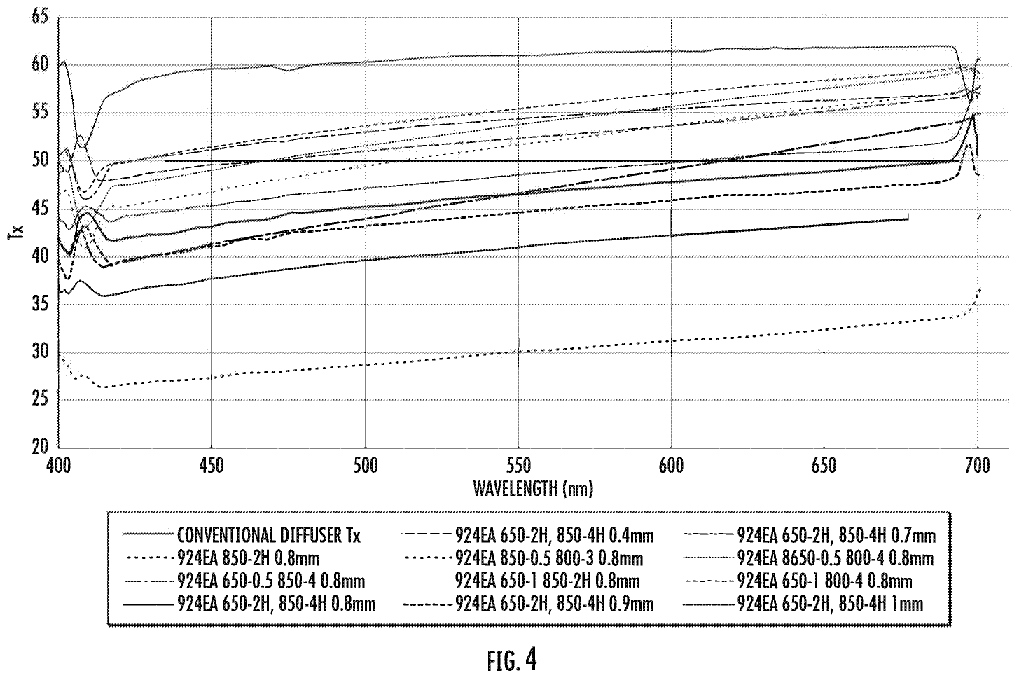

FIG. 4 shows transmission spectra of an incumbent polymer diffuser (referred to as Conventional Diffuser) and modified fusion formable glass ceramic 924EA. Modified 924EA was heat treated for a wide range of times and temperatures at thicknesses of 0.4, 0.7, 0.8, 0.9, and 1 mm. The transmission spectra illustrates that if there is too much P₂O₅ in the composition, even at the lower limit of the target glass diffuser thickness of 0.5 mm, the glass composition may not be made sufficiently transparent, despite still producing largely wavelength independent scattering across the visible spectrum. However, if the glass composition is used as a thin (such as less than or equal to 0.4 mm) clad layer of a double fusion laminate, the transmittance may be increased and tuned depending on the core/clad thickness ratio and total laminate thickness.

Compositions of fusion formable ceramic glass were investigated to increase the total transmittance and maintain wavelength independent scattering by lowering the concentration of P₂O₅ in the composition and optimizing the heat treatment schedule. The range of compositions developed are provided in Table 3, and Reference 924EA is listed in Table 3 as a reference or conventional composition.

TABLE 3
Compositions of fusion formable ceramic glass samples

| | Samples As-Batched | | | | | |
|---|---|---|---|---|---|---|
| | Reference | | | | | |
| Mol % | 924EA | 924ELD | 924ELE | 924ELF | 924ENP | 924ENQ |
| SiO₂ | 79.71 | 79.72 | 79.74 | 79.75 | 79.77 | 79.79 |
| Al₂O₃ | 5.43 | 5.44 | 5.44 | 5.44 | 5.44 | 5.44 |
| Li₂O | 10.69 | 10.69 | 10.69 | 10.69 | 10.69 | 10.70 |
| Na₂O | 0.12 | 0.11 | 0.11 | 0.11 | 0.11 | 0.11 |
| K₂O | 3.84 | 3.84 | 3.84 | 3.84 | 3.84 | 3.84 |
| MgO | 0.00 | 0.00 | 0.00 | 0.00 | 0.00 | 0.00 |
| CaO | 0.00 | 0.00 | 0.00 | 0.00 | 0.00 | 0.00 |
| SnO₂ | 0.00 | 0.00 | 0.00 | 0.00 | 0.00 | 0.00 |
| ZnO | 0.00 | 0.00 | 0.00 | 0.00 | 0.00 | 0.00 |
| P₂O₅ | 0.2136 | 0.1910 | 0.1698 | 0.1486 | 0.1274 | 0.1062 |
| Fe₂O₃ | 0.00 | 0.00 | 0.00 | 0.00 | 0.00 | 0.00 |
| TiO₂ | 0.00 | 0.01 | 0.01 | 0.01 | 0.01 | 0.01 |
| SO₃ | 0.00 | 0.00 | 0.00 | 0.00 | 0.00 | 0.00 |
| ZrO₂ | 0.00 | 0.00 | 0.00 | 0.00 | 0.00 | 0.00 |
| Total | 100.00 | 100.00 | 100.00 | 100.00 | 100.00 | 100.00 |
| R₂O − AL₂O₃ | 9.2 | 9.2 | 9.2 | 9.2 | 9.2 | 9.2 |
| R₂O + Al₂O₃ | 20.1 | 20.1 | 20.1 | 20.1 | 20.1 | 20.1 |
| | Samples As-Batched (Continued) | | | | | |
| Mol % | 924ENR | 924ENS | 924ENT | 924ENU | 924EPI | 924EPJ |
| SiO₂ | 79.80 | 79.82 | 79.84 | 79.85 | 79.72 | 80.31 |
| Al₂O₃ | 5.44 | 5.44 | 5.44 | 5.45 | 5.44 | 5.28 |
| Li₂O | 10.70 | 10.70 | 10.70 | 10.70 | 10.69 | 10.37 |
| Na₂O | 0.11 | 0.11 | 0.11 | 0.12 | 0.11 | 0.11 |
| K₂O | 3.84 | 3.84 | 3.84 | 3.84 | 3.84 | 3.73 |
| MgO | 0.00 | 0.00 | 0.00 | 0.00 | 0.00 | 0.00 |
| CaO | 0.00 | 0.00 | 0.00 | 0.00 | 0.00 | 0.00 |
| SnO₂ | 0.00 | 0.00 | 0.00 | 0.00 | 0.05 | 0.05 |
| ZnO | 0.00 | 0.00 | 0.00 | 0.00 | 0.00 | 0.00 |
| P₂O₅ | 0.0850 | 0.0638 | 0.0425 | 0.0213 | 0.1400 | 0.1359 |
| Fe₂O₃ | 0.00 | 0.00 | 0.00 | 0.00 | 0.00 | 0.00 |
| TiO₂ | 0.01 | 0.01 | 0.01 | 0.01 | 0.01 | 0.01 |
| SO₃ | 0.00 | 0.00 | 0.00 | 0.00 | 0.00 | 0.00 |
| ZrO₂ | 0.00 | 0.00 | 0.00 | 0.00 | 0.00 | 0.00 |
| Total | 100.00 | 100.00 | 100.00 | 100.00 | 100.00 | 100.00 |
| R₂O − AL₂O₃ | 9.2 | 9.2 | 9.2 | 9.2 | 9.2 | 8.9 |
| R₂O + Al₂O₃ | 20.1 | 20.1 | 20.1 | 20.1 | 20.1 | 19.5 |

| | Samples As-Batched (Continued) | | | | |
|---|---|---|---|---|---|
| Mol % | 924EPK | 924EPL | 924EPM | 924EPN | 924EZ |
| SiO₂ | 80.86 | 81.39 | 81.89 | 81.95 | 80.09 |
| Al₂O₃ | 5.13 | 4.99 | 4.86 | 4.86 | 5.40 |
| Li₂O | 10.08 | 9.80 | 9.54 | 9.54 | 10.59 |
| Na₂O | 0.11 | 0.10 | 0.10 | 0.10 | 0.00 |
| K₂O | 3.62 | 3.52 | 3.43 | 3.43 | 3.80 |
| MgO | 0.00 | 0.00 | 0.00 | 0.00 | 0.00 |
| CaO | 0.00 | 0.00 | 0.00 | 0.00 | 0.00 |
| SnO₂ | 0.05 | 0.05 | 0.04 | 0.04 | 0.00 |
| ZnO | 0.00 | 0.00 | 0.00 | 0.00 | 0.00 |
| P₂O₅ | 0.1320 | 0.1284 | 0.1250 | 0.0625 | 0.1110 |
| Fe₂O₃ | 0.00 | 0.00 | 0.00 | 0.00 | 0.00 |
| TiO₂ | 0.01 | 0.01 | 0.01 | 0.01 | 0.00 |
| SO₃ | 0.00 | 0.00 | 0.00 | 0.00 | 0.00 |
| ZrO₂ | 0.00 | 0.00 | 0.00 | 0.00 | 0.00 |
| Total | 100.00 | 100.00 | 100.00 | 100.00 | 100.00 |
| R₂O − AL₂O₃ | 8.7 | 8.4 | 8.2 | 8.2 | 9.0 |
| R₂O + Al₂O₃ | 18.9 | 18.4 | 17.9 | 17.9 | 19.8 |

As shown in Table 3, when the P₂O₅ concentration was between 0.1486 mole percent (mol %) (such as in Sample 924ELF) and 0.111 mole percent (mol %) (such as in Sample 924EZ), wavelength independent scattering was maintained and a transmittance of 60% was achieved at thicknesses greater than 0.5 mm.

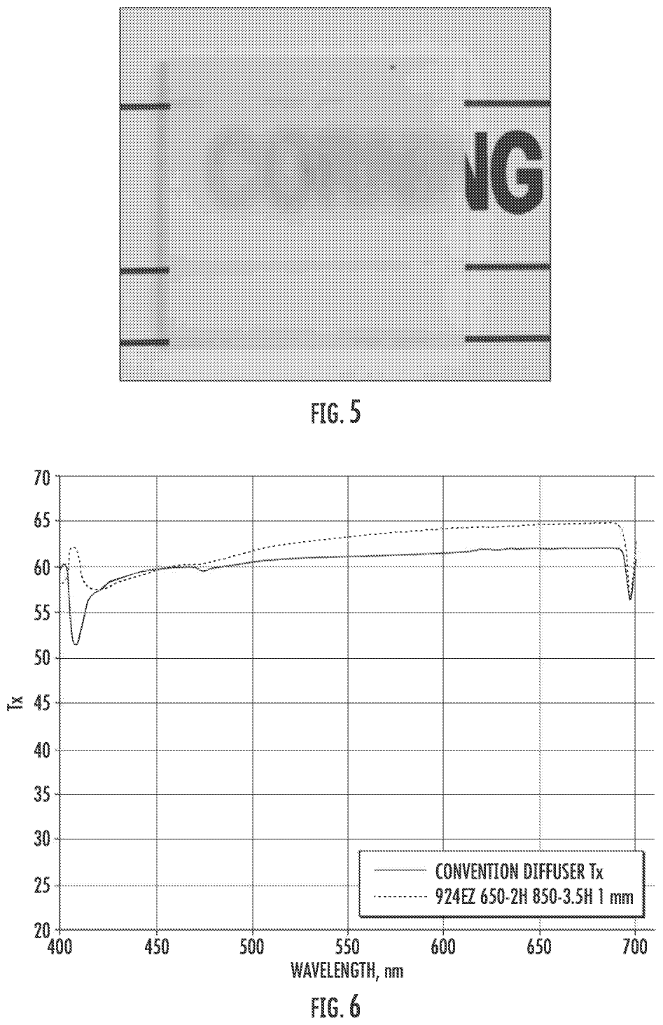

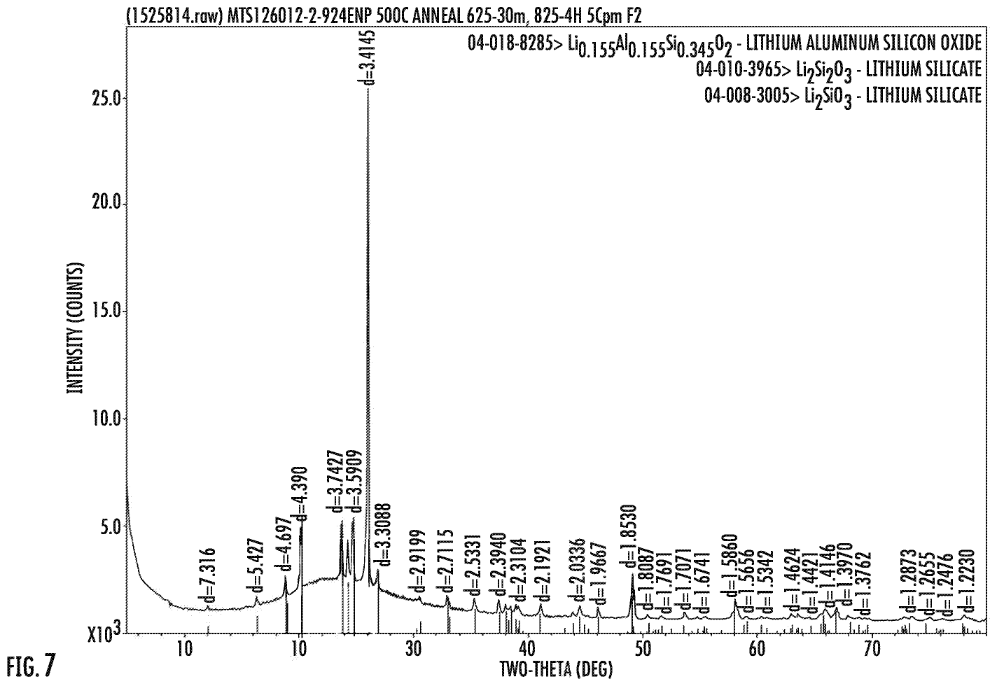

FIG. 5 shows an image of fusion formable glass ceramic 924EZ at 1 mm thickness. FIG. 6 shows the transmission spectra of an incumbent polymer diffuser (referred to as Conventional Diffuser) versus the 1 mm thick 924EZ heat treated at 650° C. for 2 hours and then at 850° C. for 3.5 hours. A 5° C. per minute ramp rate was used for the heat treatment. As shown in FIG. 6, the total transmittance of a 1 mm thick sample of 924EZ produces a near identical optical profile to the incumbent polymer diffuser.

FIG. 7 shows the powder XRD profile of a sample of 924ENP (an analog to 924EZ in FIGS. 5-6) heat treated at 625° C. for 30 minutes and then at 825° C. for 4 hours.

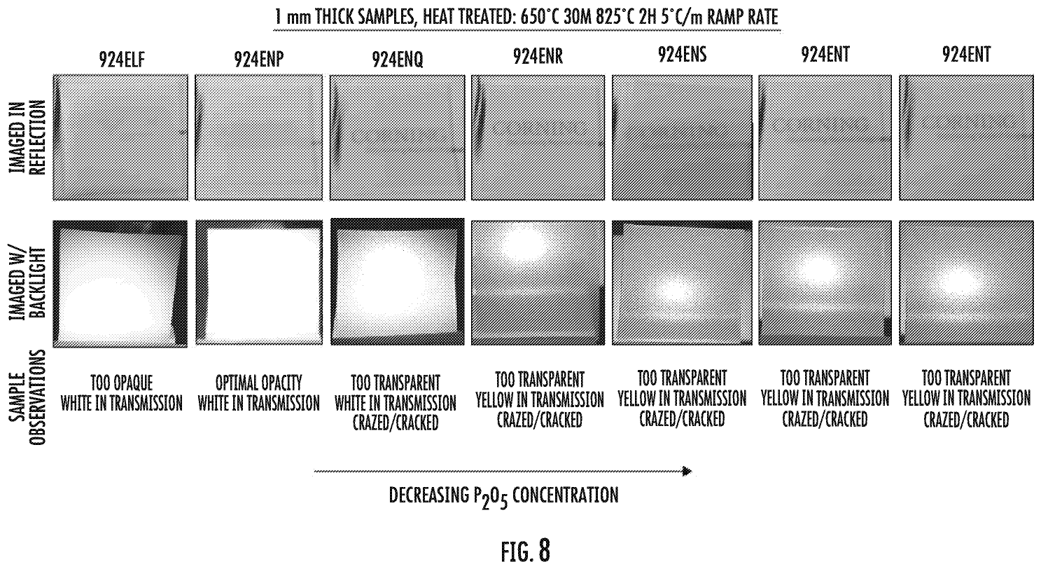

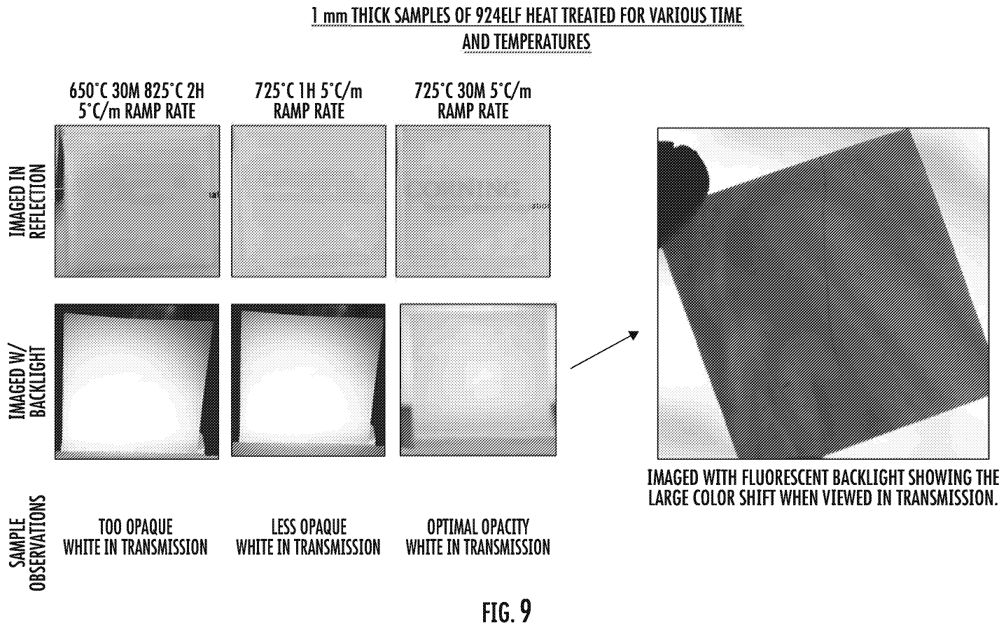

If the P₂O₅ concentration falls below the concentration of 924EZ (such as in samples 924ENQ-924ENU), the glass fails to produce sufficient scattering and becomes too transparent. FIG. 8 shows images in reflection and transmission of 924ELF, 924ENP, 924ENQ, 924ENR, 924ENS, 924ENT, and 924ENU heat treated at 625° C. for 30 minutes and then at 825° C. for 2 hours. The images show that when the P₂O₅ concentration exceeds that of 924ENP, the ceramic glass becomes too opaque. When the P₂O₅ concentration falls below that of 924ENP, the ceramic glass fails to become sufficiently opaque, exhibits wavelength dependent scattering, and cracks/crazes during heat treatment. As shown in FIG. 8, the ceramic glass samples exhibited surface cracking and warping, likely due to the small number of crystals with dissimilar CTE to the host glass. The ability to tune the transmittance with such a small change in P₂O₅ concentration, such as 0.02 mol %, was surprising.

Without being bound by theory, a narrow range of P₂O₅ concentration may facilitate the nucleation of a sufficiently small number of crystals that coarsen to a size greater than or equal to 1 μm, thus providing wavelength independent scattering when heat treated and also providing greater than 60% transmission. If the P₂O₅ concentration is too high, too many nuclei are formed, and the material becomes too opaque when heat treated to promote wavelength independent scattering. If the P₂O₅ concentration is too low, too few nuclei form, thereby resulting in insufficient light scattering.

FIG. 9 shows images of 924ELF heat treated for varying heat treatment times and temperatures. The images show that if the P₂O₅ concentration is too high (such as in glass code 924ELF), when the sample is heat treated to produce crystals coarse enough to achieve wavelength independent scattering, the ceramic glass is too opaque (see sample heat treated at 625° C. for 30 minutes and then at 825° C. for 2 hours). FIG. 9 also shows that while decreasing the heat treatment time and or temperature can facilitate an increase in the total transmittance, the crystals fail to become sufficiently coarse to produce wavelength independent scattering, and thus the samples may appear red in transmission instead of white.

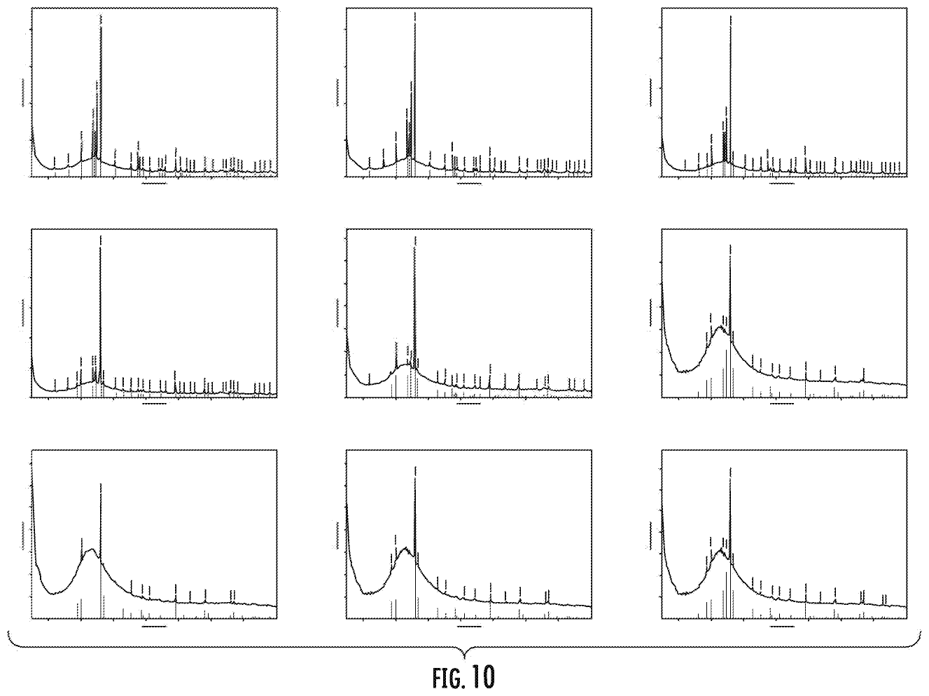

A shorter and or lower temperature heat treatment of a glass ceramic with too much P₂O₅ will allow an increase in transmittance but will not produce wavelength independent scattering. Thus, such a sample will appear yellow or red in transmission, not white. This is because too many nuclei are formed, thereby resulting in a large quantity of small crystals that fail to coarsen to a size sufficiently large enough to produce wavelength independent scattering. An example of this is shown in FIG. 9, where 924ELF is heat treated for various times and temperatures. At an appropriately long cycle (e.g., 650° C. for 30 minutes followed by 825° C. for 2 hours with 5° C./m ramp rates), the glass ceramic is white in transmission, but too opaque to meet 60% transmittance at 1 mm thickness. At shorter and lower temperature heat treatment cycles, the transmittance increases to the target 60% transmittance value, but is no longer white in transmission, instead exhibiting a red color due to wavelength dependent scattering. Accordingly, ceramic glass compositions according to the present disclosure provide both the optimal concentration of nucleating agent and the heat treatment schedule to create a suitable diffuser opal. Such a diffuser opal may be referred to as a coarse-grained low crystallinity glass ceramic. In an embodiment, the glass ceramic may be zirconia nucleated. Powder XRD, Raman, and SEM are the primary techniques to quantify the crystallite size, morphology, and concentration in the glass ceramics. FIG. 10 shows powder XRD of 924ELD-F and 924ENP-U heat treated at 625° C. for 30 minutes and then at 825° C. for 2 hours with 5° C./m ramp rates.

Ceram schedule also plays a role in achieving the opal glass. For composition 924ELF, single stage heat treatments at temperatures from about 700° C. to about 850° C. were employed at times ranging from 15 minutes to 4 hours. Typically, samples were loaded at room temperature (such as about 25° C.), ramped to the target temperature at 5° C. per minute, held at temperature for the desired time, and cooled back to room temperature at the same 5° C. per minute ramp rate. For compositions that contain less P₂O₅ than 924ELF (i.e., 924ENP), a two-step heat treatment schedule may be required wherein the cycles start with a nucleation step at temperatures from about 600° C. to about 650° C. for times between 15 and 90 minutes followed by a growth heat treatment step at temperatures from about 750° C. to about 850° C. for times between 1.5-4 hours.

In an embodiment, forming a ceramic glass composition may comprise a ceraming step. In an embodiment, the ceraming step may comprise a single stage heat treatment at a temperature from 700° C. to 850° C. The single stage heat treatment may last for a time period from 15 minutes to 4 hours. In an embodiment, the ceraming step may comprise a two-step heat treatment comprising a nucleation step at a temperature from 600° C. to 650° C. and a growth step at a temperature from 750° C. to 850° C. The nucleation step may last for a time period from about 15 minutes to about 90 minutes. The growth step may last for a time period from about 1.5 hours to about 4 hours.

In an embodiment, a ceramic glass composition or a ceramable glass composition may be configured for single fusion forming. In an embodiment, the ceramic glass composition may be configured for use as a light diffuser.

In an embodiment, a single fusion ceramic glass composition may comprise the composition of Sample 924ELF. The ceramic glass composition may comprise about 79.75 mol % SiO₂, about 5.44 mol % Al₂O₃, about 10.69 mol % Li₂O, about 0.11 mol % Na₂O, about 3.84 mol % K₂O, about 0.1486 mol % P₂O₅, and about 0.01 mol % TiO₂.

In an embodiment, a single fusion ceramic glass composition may comprise the composition of Sample 924ENP. The ceramic glass composition may comprise about 79.77 mol % SiO₂, about 5.44 mol % Al₂O₃, about 10.69 mol % Li₂O, about 0.11 mol % Na₂O, about 3.84 mol % K₂O, about 0.1274 mol % P₂O₅, and about 0.01 mol % TiO₂.

In an embodiment, a single fusion ceramic glass composition may comprise the composition of Sample 924EZ. The ceramic glass composition may comprise about 80.09 mol % SiO₂, about 5.40 mol % Al₂O₃, about 10.59 mol % Li₂O, about 3.80 mol % K₂O, and about 0.1110 mol % P₂O₅.

In an embodiment, the single fusion ceramic glass composition may comprise P₂O₅ concentrations in a range of between 0.111 mol % and 0.1486 mol %.

### Double Fusion Ceramic Glass

In an embodiment, a double fusion laminate approach to light diffusion may be provided where an opal glass is used as the clad layer with a transparent core. While such an approach may be costly because it requires a double fusion platform and a ceram step in order to develop the optical properties, the approach offers distinct advantages for display panels. For instance, with one pair of glasses (such as an opal glass clad and a transparent glass core), a wide range of optical properties and thicknesses may be created by varying the core/clad thickness ratio and ceram schedule. A double-pass diffuser, or laminate having a two layers of opal glass (opal glass clad surrounding a transparent glass core), may be more efficient at scattering light than a single layer of opal glass, thus allowing for a greater ability to hide or obscure the LED lights at a back of a display panel. By engineering a small delta CTE into the laminate pair, strength may be developed in order to allow for greater robustness and ease of handling during panel assembly.

In an aspect of the present disclosure, a glass article is provided for use in a double fusion laminate light diffuser. A double pass light diffuser having an opal glass ceramic as the clad may allow for superior spreading of light. For instance, such a configuration may have a greater ability to hide or obscure bright LEDs. A double fusion laminate opal glass may also allow for tunability of optical properties without changing composition, as the core to clad thickness ratio may be varied and the total thickness may be varied. A double fusion laminate opal may also allow for the delta CTE between the two compositions to be engineered to mechanically strengthen the laminate, thereby decreasing the risk of breakage during handling and panel assembly.

In an embodiment, the ceramic glass may be formed into a glass laminate by a double fusion method. The composition of the ceramic glass laminate may provide a moderate to high temperature ceramable opal glass or ceramic glass clad with a clear glass core. Such a ceramic glass may provide a smooth surface which allows for film deposition and may allow for reproducible optical properties through ceraming. Additionally, such a glass laminate may allow for optical advantages when used as a double pass diffuser, may allow for customizable transmittance by varying ratios of core/clad thickness, and may allow for an engineered expansion mismatch for mechanical strength. However, such a glass requires a ceraming step, may be limited by size (for example, if a sufficiently large size of glass is required that is larger than available double fusion assets), costs of fusion may be more expensive than single fusion forming, and a smooth surface may not scatter effectively as a textured surface.

In an embodiment, an opal glass ceramic or ceramic glass according to the present disclosure may be configured to be the clad layer of a double fusion laminate. Varying the core/clad thickness ratio and total laminate thickness may allow for control of the total path length of the diffuser layer, thereby allowing for a single glass composition to provide a range of optical properties without changing composition or thermal treatment conditions. Further, a double fusion laminate may allow for mechanical strengthening if a delta in CTE is engineered between the core and clad layers. Such a mechanical strengthening may allow for greater ease of sheet handling during panel assembly and robustness over operating life of the display panel. The light passing through two discrete diffuser layers as it travels through the laminate also provides an optical advantage wherein the double fusion laminate may spread and/or distribute the light more than a single diffuser layer, thus allowing for a greater ability to obscure the light emitters at a back of the panel.

An example of a double fusion laminate pair is shown in Table 4, which provides the core and clad compositions and physical properties. The core in Table 4 comprises a transparent glass core. The clad in Table 4 comprises a ceramic glass or an opal glass.

TABLE 4
Compositions, physical properties, and viscosity parameters for a double fusion
laminate light diffuser with opal glass ceramic clad and transparent glass core

| | | Core | Clad |
|---|---|---|---|
| | | 174DJX | 924EA |
| Components | SiO₂ | 60.2 | 79.71 |
| (as-batched, | Al₂O₃ | 16.5 | 5.43 |
| mol %) | MgO | 1 | 0 |
| | Li₂O | 7.25 | 10.69 |
| | Na₂O | 12.5 | 0.12 |
| | K₂O | 0.5 | 3.84 |
| | P₂O₅ | 2 | 0.2136 |
| | SnO₂ | 0.05 | 0.00 |
| | Total | 100 | 100 |
| Physical | Strain point (° C.) | 555 | 479 |
| Properties | Annealing point (° C.) | 604 | 524 |
| | Softening point (° C.) | 836.8 | 875 |
| | CTE at 300° C. (×10⁻⁷/° C.) | 90.1 | 62.4 (as-made) |
| | | | 90.4 (fully ceramed) |
| | Density (g/cm³) | 2.44 | 2.325 |
| | T(liq) [° C.] | 935 | 945 |
| | Liq Phase | unknown | spodumene |
| | Liq Visc [P] | 1,530,000 | 452,867 |
| Viscosity | A | −3.493 | −1.803 |
| Parameters | B | 9216.9 | 6526.6 |
| | To | −17.4 | 70 |
| | Temperature at 200 P (° C.) | 1573 | 1660 |
| | Temperature at 35,000 P (° C.) | 1129 | 1098 |
| | Temperature at 200,000 P (° C.) | 1031 | 988 |

In an embodiment, a laminate is provided, wherein a core of the laminate comprises a translucent glass, and wherein a cladding of the laminate comprises a glass ceramic according to compositions described herein. The laminate may comprise a diffusion glass laminate, such as for use in a display panel. The opal glass or glass ceramic may comprise a thin clad layer of the laminate. Such a configuration may result in greater spreading of the light because the light passes through an opal glass layer twice.

In a first (1) aspect, a glass composition comprises from about 60 mol % to about 82 mol % SiO₂, from about 2.1 mol % to about 12 mol % Al₂O₃, from about 0 mol % to about 15 mol % B₂O₃, from about 5 mol % to about 18 mol % Na₂O, from about 0 mol % to about 3 mol % MgO, from about 2.5 mol % to about 12 mol % CaO, and from about 0.15 mol % to about 7 mol % P₂O₅.

In a second (2) aspect, for the glass composition according to aspect 1, the composition comprises from about 63 mol % to about 80 mol % SiO₂, from about 2.5 mol % to about 8 mol % Al₂O₃, from about 0 mol % to about 10 mol % B₂O₃, from about 7 mol % to about 15 mol % Na₂O, from about 0 mol % to about 2.5 mol % MgO, from about 3 mol % to about 10 mol % CaO, and from about 0.5 mol % to about 5.5 mol % P₂O₅.

In a third (3) aspect, for the glass composition according to aspect 2, the composition comprises from about 65 mol % to about 77 mol % SiO₂, from about 3 mol % to about 6 mol % Al₂O₃, from about 0 mol % to about 7.5 mol % B₂O₃, from about 10 mol % to about 12 mol % Na₂O, from about 0 mol % to about 1 mol % MgO, from about 4 mol % to about 8.5 mol % CaO, and from about 1 mol % to about 4 mol % P₂O₅.

In a fourth (4) aspect, for the glass composition according to any of aspects 1 to 3, the glass composition comprises a spontaneously opalizing glass composition.

In a fifth (5) aspect, for the glass composition according to any of aspects 1 to 4, the glass composition opalizes without requiring heat treatment.

In a sixth (6) aspect, for the glass composition according to any of aspects 1 to 5, the composition exhibits wavelength independent scattering of visible light.

In a seventh (7) aspect, for the glass composition according to any of aspects 1 to 6, the composition produces crystals having a size greater than or equal to 1 μm.

In an eighth (8) aspect, for the glass composition according to any of aspects 1 to 7, a targeted total transmittance value of the glass composition comprises a transmittance of 50% to 80%.

In a ninth (9) aspect, for the glass composition according to any of aspects 1 to 8, the glass composition is configured for use as a light diffuser for a backlit display panel.

In a tenth (10) aspect, for the glass composition according to any of aspects 1 to 9, the composition is configured such that the light diffuser appears white in transmission.

In an eleventh (11) aspect, for the glass composition according to any of aspects 1 to 10, the light diffuser has a thickness from 0.5 mm to 1.5 mm.

In a twelfth (12) aspect, for the glass composition according to any of aspects 1 to 11, the glass composition may be formed by rolling forming methods.

In a thirteenth (13) aspect, for the glass composition according to any of aspects 1 to 12, the glass composition comprises a textured surface.

In a fourteenth (14) aspect, for the glass composition according to any of aspects 1 to 13, the glass composition does not contain fluorine (F), barium (Ba), lead (Pb), or a combination thereof.

In a fifteenth (15) aspect, for the glass composition according to any of aspects 1 to 14, the glass composition does not contain lithium (Li), zinc (Zn), tungsten (W), molybdenum (Mo), or a combination thereof.

In a sixteenth (16) aspect, a glass composition comprises from about 79.75 mol % to about 80.09 mol % SiO₂, from about 5.40 mol % to about 5.44 mol % Al₂O₃, from about 10.59 mol % to about 10.69 mol % Li₂O, from about 0 mol % to about 0.11 mol % Na₂O, from about 3.80 mol % to about 3.84 mol % K₂O, from about 0.1110 mol % to about 0.1486 mol % P₂O₅, and from about 0 to about 0.01 mol % TiO₂.

In a seventeenth (17) aspect, for the glass composition according to aspect 16, the glass composition is a ceramic glass composition.

In an eighteenth (18) aspect, for the glass composition according to aspect 16 or aspect 17, the glass composition is configured for fusion forming.

In a nineteenth (19) aspect, for the glass composition according to any of aspects 16 to 18, the glass composition is configured for single fusion forming or double fusion forming.

In a twentieth (20) aspect, for the glass composition according to any of aspects 16 to 19, the glass composition comprises a ceraming step during forming.

In a twenty-first (21) aspect, for the glass composition according to aspect 20, the ceraming step comprises a single stage heat treatment at a temperature from 700° C. to 850° C.

In a twenty-second (22) aspect, for the glass composition according to aspect 21, the single stage heat treatment occurs for a time period from 15 minutes to 4 hours.

In a twenty-third (23) aspect, for the glass composition according to aspect 20, the ceraming step may comprise a two-step heat treatment comprising a nucleation step followed by a growth step.

In a twenty-fourth (24) aspect, for the glass composition according to aspect 23, the nucleation step is carried out at temperatures in a range from 600° C. to 650° C. from about 15 minutes to about 90 minutes.

In a twenty-fifth (25) aspect, for the glass composition according to aspect 23 or 24, the growth step is carried out at temperatures in a range from 750° C. to 850° C. from about 1.5 hours to about 4 hours.

In a twenty-sixth (26) aspect, for the glass composition according to any of aspects 16 to 25, the glass composition comprises a smooth surface from fusion forming.

In a twenty-seventh (27) aspect, for the glass composition according to any of aspects 16 to 26, the smooth surface is configured for film deposition.

In a twenty-eighth (28) aspect, for the glass composition according to any of aspects 16 to 27, the glass composition does not contain fluorine (F), barium (Ba), lead (Pb), or a combination thereof.

In a twenty-ninth (29) aspect, for the glass composition according to any of aspects 16 to 28, the glass composition exhibits wavelength independent scattering of visible light.

In a thirtieth (30) aspect, for the glass composition according to any of aspects 16 to 29, the glass composition produces crystals having a size greater than or equal to 1 μm.

In a thirty-first (31) aspect, for the glass composition according to any of aspects 16 to 30, a targeted total transmittance value of the glass composition comprises a transmittance of 50% to 80%.

In a thirty-second (32) aspect, for the glass composition according to any of aspects 16 to 31, the glass composition is configured for use as a light diffuser for a backlit display panel.

In a thirty-third (33) aspect, for the glass composition according to any of aspects 16 to 32, the glass composition is configured such that the light diffuser appears white in transmission.

In a thirty-fourth (34) aspect, for the glass composition according to any of aspects 16 to 33, the light diffuser has a thickness from 0.5 mm to 1.5 mm.

In a thirty-fifth (35) aspect, a light diffuser for a backlit display panel comprises a laminate comprising: a core layer comprising a clear glass, and a clad layer comprising a ceramic glass composition.

In a thirty-sixth (36) aspect, for the light diffuser according to aspect 35, the ceramic glass composition is a glass composition according to any of aspect 16 to 34.

In a thirty-seventh (37) aspect, for the light diffuser according to aspect 35 or 36, the glass composition is configured such that the light diffuser appears white in transmission.

In a thirty-eighth (38) aspect, for the light diffuser according to any of aspects 35 to 37, the light diffuser has a thickness from 0.5 mm to 1.5 mm.

In a thirty-ninth (39) aspect, for the light diffuser according to any of aspects 35 to 38, the laminate is a double fusion laminate.

In a fortieth (40) aspect, for the light diffuser according to any of aspects 35 to 39, the clad layer comprises two layers disposed on opposite surfaces of the core layer.

In a forty-first (41) aspect, for the light diffuser according to any of aspects 35 to 40, the core layer glass and the clad layer glass are selected to tune optical properties.

In a forty-second (42) aspect, for the light diffuser according to any of aspects 35 to 41, a ceram schedule during forming of the laminate is tunable.

In a forty-third (43) aspect, for the light diffuser according to any of aspects 35 to 42, a ratio of core thickness to clad thickness is tunable.

In a forty-fourth (44) aspect, for the light diffuser according to any of aspects 35 to 43, a delta coefficient of thermal expansion (CTE) between the core layer glass and the clad layer glass is tunable.

### EXAMPLES

### Sample Preparation

All opal glass or ceramic glass described herein were prepared by weighing the batch constituents, mixing the constituents, and melting at temperatures between 1300° C.-1700° C. in crucibles. Nonlimiting examples of methods of mixing include by turbula and by ball mill. Nonlimiting examples of crucibles include Pt, silica, refractory, and Pt/Rh crucibles. As an example, the prescribed time period for melting may comprise about 6 to about 32 hours.

The mixtures may be continuously melted or double melted. As an example, double melting may be employed to improve mixedness. An example of double melting may include melting the glass, pouring the molten glass into water, collecting small particles of glass from the water, and re-melting the collected small glass particles. As an example, mechanical stirring may be employed to improve homogeneity.

Glasses were cast onto a metal table to produce an ‘optical pour’ or ‘patty’ of glass. As an example, some melts may be cast onto a steel table and then rolled into sheets using a steel roller. The glass may be annealed at temperatures between about 380° C. to about 600° C. To develop and control optical absorbance, the materials may be heat treated for times ranging from about 5 minutes to about 500 minutes at temperatures ranging from about 425° C. to about 900° C. in ambient air electric ovens. As the cooling rate from the peak heat treatment temperature may be critical in developing the specific absorbance profile, the cooling rate may be varied from very slow cooling (1° C./minute) to very rapid cooling in ambient air by removing the sample from the oven while still at temperature.

### Fusion Formable Opal Glass Samples

A table of compositions (mol %) for samples of fusion formable opal glass, also referred to as glass ceramic compositions formed by fusion, is provided in Table 5.

TABLE 5
Composition of Fusion Formable Opal Samples

| Composition | Sample | | | | | | |
|---|---|---|---|---|---|---|---|
| (mol %) | 924EZ | 924ELA | 924ELB | 924ELC | 924ELD | 924ELE | 924ELF |
| SiO₂ | 80.090 | 79.199 | 79.295 | 79.489 | 79.823 | 79.840 | 79.857 |
| Al₂O₃ | 5.400 | 5.401 | 5.407 | 5.420 | 5.443 | 5.444 | 5.445 |
| B₂O₃ | 0.000 | 0.000 | 0.000 | 0.000 | 0.000 | 0.000 | 0.000 |
| Li₂O | 10.600 | 10.616 | 10.629 | 10.655 | 10.700 | 10.702 | 10.705 |
| Na₂O | 0.000 | 0.000 | 0.000 | 0.000 | 0.000 | 0.000 | 0.000 |
| K₂O | 3.800 | 3.812 | 3.817 | 3.826 | 3.842 | 3.843 | 3.844 |
| MgO | 0.000 | 0.000 | 0.000 | 0.000 | 0.000 | 0.000 | 0.000 |
| ZnO | 0.000 | 0.000 | 0.000 | 0.000 | 0.000 | 0.000 | 0.000 |
| P₂O₅ | 0.110 | 0.000 | 0.000 | 0.000 | 0.191 | 0.170 | 0.149 |
| SnO₂ | 0.000 | 0.000 | 0.000 | 0.000 | 0.000 | 0.000 | 0.000 |
| ZrO₂ | 0.000 | 0.971 | 0.851 | 0.609 | 0.000 | 0.000 | 0.000 |
| TOTALS | 100 | 100 | 100 | 100 | 100 | 100 | 100 |

| Composition | Sample (Continued) | | | | | | |
|---|---|---|---|---|---|---|---|
| (mol %) | 924ENP | 924ENQ | 924ENR | 924ENS | 924ENT | 924ENU | 924EPI |
| SiO₂ | 79.874 | 79.891 | 79.908 | 79.925 | 79.942 | 79.959 | 79.820 |
| Al₂O₃ | 5.447 | 5.448 | 5.449 | 5.450 | 5.451 | 5.452 | 5.446 |
| B₂O₃ | 0.000 | 0.000 | 0.000 | 0.000 | 0.000 | 0.000 | 0.000 |
| Li₂O | 10.707 | 10.709 | 10.711 | 10.714 | 10.716 | 10.718 | 10.700 |
| Na₂O | 0.000 | 0.000 | 0.000 | 0.000 | 0.000 | 0.000 | 0.000 |
| K₂O | 3.845 | 3.846 | 3.846 | 3.847 | 3.848 | 3.849 | 3.844 |
| MgO | 0.000 | 0.000 | 0.000 | 0.000 | 0.000 | 0.000 | 0.000 |
| ZnO | 0.000 | 0.000 | 0.000 | 0.000 | 0.000 | 0.000 | 0.000 |
| P₂O₅ | 0.128 | 0.106 | 0.085 | 0.064 | 0.043 | 0.021 | 0.140 |
| SnO₂ | 0.000 | 0.000 | 0.000 | 0.000 | 0.000 | 0.000 | 0.050 |
| ZrO₂ | 0.000 | 0.000 | 0.000 | 0.000 | 0.000 | 0.000 | 0.000 |
| TOTALS | 100 | 100 | 100 | 100 | 100 | 100 | 100 |

| Composition | Sample (Continued) | | | | | | |
|---|---|---|---|---|---|---|---|
| (mol %) | 924EPJ | 924EPK | 924EPL | 924EPM | 924EPN | 932OE | 932OF |
| SiO₂ | 80.408 | 80.963 | 81.488 | 81.984 | 82.047 | 69.055 | 68.909 |
| Al₂O₃ | 5.287 | 5.137 | 4.996 | 4.862 | 4.862 | 5.400 | 5.400 |
| B₂O₃ | 0.000 | 0.000 | 0.000 | 0.000 | 0.000 | 3.460 | 3.460 |
| Li₂O | 10.388 | 10.094 | 9.816 | 9.553 | 9.552 | 0.000 | 0.000 |
| Na₂O | 0.000 | 0.000 | 0.000 | 0.000 | 0.000 | 11.072 | 11.072 |
| K₂O | 3.732 | 3.626 | 3.526 | 3.432 | 3.432 | 0.000 | 0.000 |
| MgO | 0.000 | 0.000 | 0.000 | 0.000 | 0.000 | 10.818 | 10.818 |
| ZnO | 0.000 | 0.000 | 0.000 | 0.000 | 0.000 | 0.000 | 0.000 |
| P₂O₅ | 0.136 | 0.132 | 0.129 | 0.125 | 0.063 | 0.145 | 0.291 |
| SnO₂ | 0.049 | 0.047 | 0.046 | 0.045 | 0.045 | 0.048 | 0.048 |
| ZrO₂ | 0.000 | 0.000 | 0.000 | 0.000 | 0.000 | 0.000 | 0.000 |
| TOTALS | 100 | 100 | 100 | 100 | 100 | 100 | 100 |
| Composition | Sample (Continued) | | | | | | |
| (mol %) | 932OG | 932OH | 932OI | 932OJ | 932OK | 932OL | 932OM |
| SiO₂ | 68.618 | 72.515 | 72.370 | 72.079 | 73.787 | 73.648 | 73.370 |
| Al₂O₃ | 5.400 | 5.400 | 5.400 | 5.400 | 5.150 | 5.150 | 5.150 |
| B₂O₃ | 3.460 | 0.000 | 0.000 | 0.000 | 0.000 | 0.000 | 0.000 |
| Li₂O | 0.000 | 0.000 | 0.000 | 0.000 | 0.000 | 0.000 | 0.000 |
| Na₂O | 11.072 | 11.072 | 11.072 | 11.072 | 10.560 | 10.560 | 10.560 |
| K₂O | 0.000 | 0.000 | 0.000 | 0.000 | 0.000 | 0.000 | 0.000 |
| MgO | 10.818 | 10.818 | 10.818 | 10.818 | 10.318 | 10.318 | 10.318 |
| ZnO | 0.000 | 0.000 | 0.000 | 0.000 | 0.000 | 0.000 | 0.000 |
| P₂O₅ | 0.582 | 0.145 | 0.291 | 0.582 | 0.139 | 0.277 | 0.555 |
| SnO₂ | 0.048 | 0.049 | 0.048 | 0.049 | 0.046 | 0.046 | 0.046 |
| ZrO₂ | 0.000 | 0.000 | 0.000 | 0.000 | 0.000 | 0.000 | 0.000 |
| TOTALS | 100 | 100 | 100 | 100 | 100 | 100 | 100 |

| Composition | Sample (Continued) | | | | | | |
|---|---|---|---|---|---|---|---|
| (mol %) | 924EQQ | 924EQR | 924EQS | 924EQT | 924EQU | 924EQV | 924ERC |
| SiO₂ | 81.813 | 81.404 | 80.904 | 82.371 | 82.819 | 83.244 | 81.914 |
| Al₂O₃ | 4.884 | 4.860 | 4.860 | 4.730 | 4.610 | 4.496 | 4.860 |
| B₂O₃ | 0.000 | 0.000 | 0.000 | 0.000 | 0.000 | 0.000 | 0.000 |
| Li₂O | 9.587 | 9.539 | 9.539 | 9.294 | 9.058 | 8.834 | 9.539 |
| Na₂O | 0.103 | 0.103 | 0.103 | 0.100 | 0.098 | 0.096 | 0.103 |
| K₂O | 3.447 | 3.430 | 3.430 | 3.339 | 3.254 | 3.174 | 3.430 |
| MgO | 0.000 | 0.000 | 0.000 | 0.000 | 0.000 | 0.000 | 0.000 |
| ZnO | 0.000 | 0.500 | 0.999 | 0.000 | 0.000 | 0.000 | 0.000 |
| P₂O₅ | 0.126 | 0.125 | 0.125 | 0.122 | 0.119 | 0.116 | 0.115 |
| SnO₂ | 0.040 | 0.040 | 0.040 | 0.043 | 0.042 | 0.041 | 0.040 |
| ZrO₂ | 0.000 | 0.000 | 0.000 | 0.000 | 0.000 | 0.000 | 0.000 |
| TOTALS | 100 | 100 | 100 | 100 | 100 | 100 | 100 |

| Composition | Sample (Continued) | | | | | | |
|---|---|---|---|---|---|---|---|
| (mol %) | 924ERD | 924ERE | 924ERF | 924ERG | 924ERH | 924ERO | 924ERP |
| SiO₂ | 81.924 | 81.934 | 83.271 | 83.281 | 83.291 | 83.177 | 83.092 |
| Al₂O₃ | 4.860 | 4.860 | 4.490 | 4.490 | 4.490 | 4.512 | 4.535 |
| B₂O₃ | 0.000 | 0.000 | 0.000 | 0.000 | 0.000 | 0.000 | 0.000 |
| Li₂O | 9.539 | 9.539 | 8.829 | 8.828 | 8.828 | 8.873 | 8.918 |
| Na₂O | 0.103 | 0.103 | 0.095 | 0.096 | 0.096 | 0.096 | 0.096 |
| K₂O | 3.430 | 3.430 | 3.170 | 3.170 | 3.170 | 3.186 | 3.202 |
| MgO | 0.000 | 0.000 | 0.000 | 0.000 | 0.000 | 0.000 | 0.000 |
| ZnO | 0.000 | 0.000 | 0.000 | 0.000 | 0.000 | 0.000 | 0.000 |
| P₂O₅ | 0.105 | 0.095 | 0.106 | 0.096 | 0.086 | 0.116 | 0.117 |
| SnO₂ | 0.040 | 0.040 | 0.040 | 0.040 | 0.040 | 0.040 | 0.040 |
| ZrO₂ | 0.000 | 0.000 | 0.000 | 0.000 | 0.000 | 0.000 | 0.000 |
| TOTALS | 100 | 100 | 100 | 100 | 100 | 100 | 100 |

| | |
|---|---|
| Composition | Sample (Continued) |

| (mol %) | 924ERQ | 924ERR | 924ERS | 924ERT |
|---|---|---|---|---|
| SiO₂ | 83.006 | 84.404 | 84.333 | 84.254 |
| Al₂O₃ | 4.558 | 4.184 | 4.201 | 4.222 |
| B₂O₃ | 0.000 | 0.000 | 0.000 | 0.000 |
| Li₂O | 8.963 | 8.222 | 8.260 | 8.302 |
| Na₂O | 0.097 | 0.090 | 0.090 | 0.090 |
| K₂O | 3.218 | 2.954 | 2.968 | 2.983 |
| MgO | 0.000 | 0.000 | 0.000 | 0.000 |
| ZnO | 0.000 | 0.000 | 0.000 | 0.000 |
| P₂O₅ | 0.117 | 0.108 | 0.108 | 0.109 |
| SnO₂ | 0.041 | 0.038 | 0.040 | 0.040 |
| ZrO₂ | 0.000 | 0.000 | 0.000 | 0.000 |
| TOTALS | 100 | 100 | 100 | 100 |

Table 6 provides physical properties for the fusion formable opal glass samples investigated, along with liquidus, viscosity, and zircon breakdown measurements for some of the samples.

TABLE 6
Features of Fusion Formable Opal Glass Samples

| | Sample | | | | |
|---|---|---|---|---|---|
| Feature | 924EZ | 924ELA | 924ELB | 924ELC | 924ELD |
| Softening Point (° C.) | 778 | 778.8(774.1) | 774.6(774.8) | 772.6(771) | |
| Anneal Point (° C.) | 524 | 536(534.8) | 534(532.5) | 531(529.2) | |
| Strain Point (° C.) | 477 | 491(488.6) | 489(486.8) | 486(483.3) | |
| CTE(EXP-bar RT-300 C.) | 6.17 | 60.4 | 60.8 | 61.3 | |
| Density (g/cm\hat{ }3) | 2.324 | 2.358 | 2.354 | 2.346 | |
| T(liq) [° C.] | 960 | 905 | 925 | 915 | 981 |
| Liq Phase | tridymite | Quartz | Quartz | Quartz | Phosphate |
| Liq Visc [P] | | 985485 | 663230 | 642245 | 221000 |
| Zr breakdown | | | | | >1380 |

| | Sample (Continued) | | | | |
|---|---|---|---|---|---|
| Feature | 924ELE | 924ELF | 924ENP | 924ENQ | 924ENR |
| Softening Point (° C.) | | | | | |
| Anneal Point (° C.) | | | | | |
| Strain Point (° C.) | | | | | |
| CTE(EXP-bar RT-300 C.) | | | | | |
| Density (g/cm\hat{ }3) | | | | | |
| T(liq) [° C.] | 979 | 970 | 1040 | 1020 | 1025 |
| Liq Phase | Phosphate | Phosphate | | | |
| Liq Visc [P] | | 209000 | | | |
| Zr breakdown | | >1380 | | | |

| | Sample (Continued) | | | | |
|---|---|---|---|---|---|
| Feature | 924EPI | 924EPJ | 924EPK | 924EPL | 924EPM |
| Softening Point (° C.) | | | | | |
| Anneal Point (° C.) | 524 | 527 | 530 | 532 | 534 |
| Strain Point (° C.) | 478 | 482 | 484 | 485 | 487 |
| CTE(EXP-bar RT-300 C.) | 62.7(105.0) | 60.1(102.2) | 59.3(101.6) | 57.4(113.2) | 56.8(125.3) |
| Density (g/cm\hat{ }3) | 2.329 | 2.325 | 2.322 | 2.318 | 2.315 |
| T(liq) [° C.] | 935 | 1000 | 1015 | 1050 | 1075 |
| Liq Phase | Quartz | Quartz | Tridymite | Tridymite | |
| Liq Visc [P] | 443937.292 | 170527.068 | 145721.89 | 103251.92 | |
| Zr breakdown | >1380 | >1380 | >1375 | >1370 | |

| | Sample (Continued) | | | | |
|---|---|---|---|---|---|
| Feature | 924EQQ | 924EQR | 924EQS | 924EQT | 924EQU |
| Softening Point (° C.) | 788.8 | 847.6 | N/A | N/A | N/A |
| Anneal Point (° C.) | 532.4 | 530.8 | 530.2 | 536.3 | 539.5 |
| Strain Point (° C.) | 485.2 | 482.9 | 482.8 | 488.9 | 491.6 |
| CTE(EXP-bar RT-300 C.) | 58.1(114.8) | 58.4(114.8) | 58.1(120.0) | 56.8(130.3) | 55.6(143.0) |
| Density (g/cm\hat{ }3) | 2.319 | 2.326 | 2.336 | 2.312 | 2.309 |
| T(liq) [° C.] | 1065 | 1025 | 1050 | 1085 | 1135 |
| Liq Phase | | Tridymite | | | |
| Liq Visc [P] | | 156217.533 | | | |
| Zr breakdown | | | | | |

| | Sample (Continued) | | | | |
|---|---|---|---|---|---|
| Feature | 924EQV | 924ERE | 924ERH | 924ERO | 924ERP |
| Softening Point (° C.) | N/A | | | (805) | n/a-Xtal |
| Anneal Point (° C.) | 541.2 | | | 540.6 | 539.1 |
| Strain Point (° C.) | 491.6 | | | 492.2 | 489.9 |
| CTE(EXP-bar RT-300 C.) | 55.1(137.5) | (79.3) | (109.9) | 52.6 | 55.8 |
| Density (g/cm\hat{ }3) | 2.307 | | | 2.309 | 2.313 |
| T(liq) [° C.] | 1150 | | | 1135 | 1110 |
| Liq Phase | | | | | |
| Liq Visc [P] | | | | | |
| Zr breakdown | | | | >1240 | >1285 |

Sample (Continued)

| Feature | 924ERQ | 924ERR | 924ERS | 924ERT |
|---|---|---|---|---|
| Softening Point (° C.) | 804 | n/a-Xtal | n/a-Xtal | |
| Anneal Point (° C.) | 537.7 | 549.3 | 547.4 | 545.9 |
| Strain Point (° C.) | 488.7 | 499.7 | 497.6 | 495.6 |
| CTE(EXP-bar RT-300 C.) | 54.3 | 50.9 | 51.8 | 52.2 |
| Density (g/cm\hat{ }3) | 2.318 | 2.298 | 2.302 | 2.306 |
| T(liq) [° C.] | 1115 | 1210 | 1215 | 1180 |
| Liq Phase | | | | |
| Liq Visc [P] | | | | |
| Zr breakdown | >1295 | >1305 | >1310 | >1300 |

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, and like aspects, and ranges thereof, are for illustration only; they do not exclude other defined values or other values within defined ranges. The systems, kits, and methods of the disclosure can include any value or any combination of the values, specific values, more specific values, and preferred values described herein, including explicit or implicit intermediate values and ranges.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. An opal glass comprising:
from about 60 mol % to about 82 mol % SiO₂,
from about 2.1 mol % to about 12 mol % Al₂O₃,
from about 0 mol % to about 15 mol % B₂O₃,
from about 5 mol % to about 18 mol % Na₂O,
from about 0 mol % to about 3 mol % MgO,
from about 2.5 mol % to about 12 mol % CaO, and
from about 0.15 mol % to about 7 mol % P₂O₅.

2. The opal glass of claim 1, wherein the composition comprises:
from about 63 mol % to about 80 mol % SiO₂,
from about 2.5 mol % to about 8 mol % Al₂O₃,
from about 0 mol % to about 10 mol % B₂O₃,
from about 7 mol % to about 15 mol % Na₂O,
from about 0 mol % to about 2.5 mol % MgO,
from about 3 mol % to about 10 mol % CaO, and
from about 0.5 mol % to about 5.5 mol % P₂O₅.

3. The opal glass of claim 2, wherein the composition comprises:
from about 65 mol % to about 77 mol % SiO₂,
from about 3 mol % to about 6 mol % Al₂O₃,
from about 0 mol % to about 7.5 mol % B₂O₃,
from about 10 mol % to about 12 mol % Na₂O,
from about 0 mol % to about 1 mol % MgO,
from about 4 mol % to about 8.5 mol % CaO, and
from about 1 mol % to about 4 mol % P₂O₅.

4-5. (canceled)

6. The opal glass of claim 1, wherein the opal glass exhibits wavelength independent scattering of visible light.

7. The opal glass of claim 6, comprising crystals having a size greater than or equal to 1 μm.

8-10. (canceled)

11. The opal glass of claim 7, wherein the opal glass has a thickness from 0.5 mm to 1.5 mm.

12. (canceled)

13. The opal glass of claim 11, wherein the opal glass composition comprises a textured surface.

14. The opal glass of claim 1, wherein the opal glass is free of fluorine (F), barium (Ba), lead (Pb), or a combination thereof.

15. The opal glass of claim 1, wherein the opal glass is free of lithium (Li), zinc (Zn), tungsten (W), molybdenum (Mo), or a combination thereof.

16. An opal glass composition comprising:
from about 79.75 mol % to about 80.09 mol % SiO₂,
from about 5.40 mol % to about 5.44 mol % Al₂O₃,
from about 10.59 mol % to about 10.69 mol % Li₂O,
from about 0) mol % to about 0.11 mol % Na₂O,
from about 3.80 mol % to about 3.84 mol % K₂O,
from about 0.1110 mol % to about 0.1486 mol % P₂O₅, and
from about 0 to about 0.01 mol % TiO₂.

17-44. (canceled)
